(19) United States
(12) Patent Application Publication
(10) Pub. No.: US 2004/0138359 A1
(43) Pub. Date: Jul. 15, 2004

(54) Environmentally Friendly Composition

(75) Inventors: Albrecht Dinkelaker, Morfelden-Walldorf (DE); Ulrich Walcher, Balzheim (DE)

Correspondence Address: Lichti, Lempert & Lasch, Patentanwalte, Bergwaldstr. 1, Karlsruhe, D-76227, DE

(73) Assignee: Ulrich Walcher, Balzheim (DE)

(21) Appl. No.: 10/627,668

(22) Filed: Jul. 28, 2003

Related U.S. Application Data
(63) Continuation of application No. PCT/DE02/00320, filed on Jan. 30, 2002.

(30) Foreign Application Priority Data
Jan. 31, 2001 (DE) 101 04 004.0

(51) Int. Cl. C08L 91/00

(52) U.S. Cl. 524/313

(57) ABSTRACT

The invention concerns an environment-friendly composition containing (A) at least one crystalline polycaprolactone (PCL) or a mixture of such polycaprolactones and (B) at least one wax having a melting point in the region between 50° C. and 180° C. or a mixture of such waxes and (C) optional further additives. The inventive composition is characterized in that the wax of the component (B) is selected from the group of castor wax, i.e. partially or completely hardened (hydrated) castor oil and/or triglycerides of partially or completely hydrated mono-, di- and/or trihydroxy carboxylic acids and carboxylic acids and/or triglycerides of partially or completely hydroxylated di-, tri- and/or polyhydroxy carboxylic acids and carboxylic acids and/or hydroxy carboxylic acid amides and/or hydroxy carboxylic acid salts, wherein the weight ratio between the component (A) and the component (B) is in the region of between approximately 05:95 and 95:05. The invention also proposes objects made from such a composition and methods for their production.

The present invention concerns an environment-friendly composition containing (A) at least one crystalline polycaprolactone (PCL) or a mixture of such polycaprolactones and (B) at least one wax having a melting point in the range between 50° C. and 180° C. or a mixture of such waxes and (C) optionally further additional substances. The invention also concerns objects produced therefrom and a method for their production.

The inventive composition is excellently suited e.g. for processing in the packaging industry. Thermoplastic compositions are of great importance in the packaging industry, since they are easier to dispose of than conventional plastic materials but have equally good processing and application properties.

It has surprisingly turned out that a composition of the above-mentioned type, having the above-mentioned positive properties, is characterized in that the wax of component (B) is selected from the group of Castor wax, i.e. partially or fully hardened (hydrated) castor oil and/or triglycerides of partially or fully hydrated mono-, di- and/or trihydroxy carboxylic acids and carboxylic acids and/or triglycerides of partially or fully hydroxylated di, tri- and/or polyhydroxy carboxylic acids and carboxylic acids and/or hydroxy carboxylic acid amides and/or hydroxy carboxylic acid salts, wherein the weight ratio between component (A) and component (B) is in the range between approximately 05:95 to 95:05.

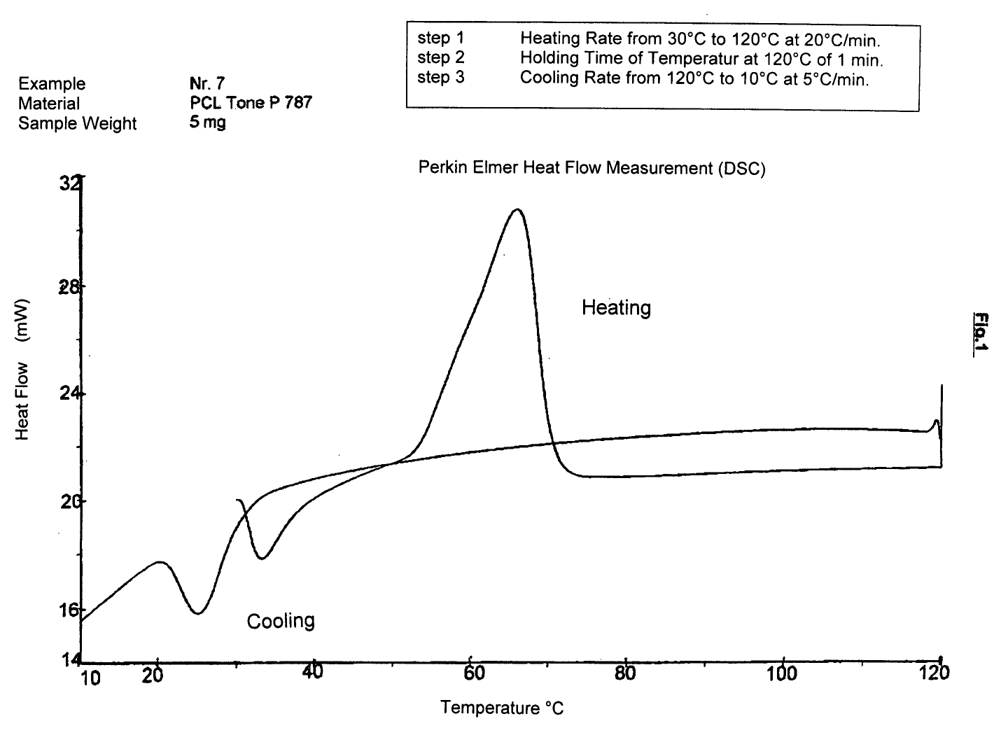

Surprisingly, the processibility of polycaprolactones into blown film is considerably improved through the inventive addition of naturally brittle wax and becomes comparable to conventional plastic materials such as e.g. polyethylene. The produced mixture can be processed with standard blown film systems and without limitations. This is already possible with a composition which contains only the two components (A) and (B) in the absence of further auxiliary processing substances and without substantially changing the mechanical properties of polycaprolactone. The inventive composition surprisingly has a distinct and fast crystallisation behavior even at temperatures of 55-60° C. compared to pure polycaprolactone (see DSC curves FIGS. 1-3). Despite the high proportion of relatively brittle wax, such as e.g. brittle castor wax, the flexibility, impact strength and elongation at tear are substantially maintained.

Films which were produced with the inventive composition surprisingly show unexpected soft touch properties after cold-stretching. The invention is defined in the claims with advantageous further developments being given in the dependent claims.

The component (A) of the inventive composition is a crystalline polycaprolactone, preferably a highly crystalline polycaprolactone. It preferably has a molecular weight of approximately 20,000 to 180,000 and a melting range of approximately 50° C. to 120° C., preferably 58° C. to 62° C. and a crystallization temperature of less than 40° C. These polycaprolactones are commercially available, e.g. under the trade name Tone® Polymer P767E and Tone® P787 Polymer (Union Carbide Corp.) or Capa® 640, Capa® 650 and Capa® 680 (Solvay Interox Ltd.).

The component (B) is preferably hardened, i.e. partially or fully hydrated castor oil (castor wax). Castor wax is in general a mixture consisting of glyceryltri-12-hydroxy stearate (approximately 70-99%) and of glycerides (approximately 1-30%) of 12-hydroxy stearic acid, stearic acid and dioxystearic acid. A castor wax is preferably used which consists of glyceryltri-12-hydroxy stearate (approximately 75-90%) and of glycerides (approximately 10-25%) of 12-hydroxy stearic acid, stearic acid and dioxy stearic acid with a iodine number of 0-5, a melting range of 81-92° C., preferably 83-88° C. This castor wax can be obtained e.g. under the trade name Loxiol® G 15 (Cognis AG) or simply as hydrated castor oil (OleoChemie AG).

While the component (B) represents preferably hardened, i.e. partially or fully hydrated castor oil (castor wax), the component (B) may, in particular, also comprise a triglyceride of hydrated mono-, di- and/or trihydroxy carboxylic acids and carboxylic acids and/or a triglyceride of hydroxylated di-, tri- and/or polyhydrxy carboxylic acids and carboxylic acids or a mixture of such triglycerides (or of several such triglycerides) with castor wax, wherein the triglyceride has a melting range of 50° C. to 180° C., in particular of 70° C. to 180° C. Also suitable as component (B) are, in particular, a hydroxy carboxylic acid amide or a mixture of such hydroxy carboxylic acid amides or several such hydroxy carboxylic acid amides with castor wax, wherein the hydroxy carboxylic acid amide has a melting range of 50° C. to 180° C., in particular of 70° C. to 180° C. and a hydroxy carboxylic acid salt or a mixture of such hydroxy carboxylic acid salts or of several such hydroxy carboxylic acid salts with castor wax, wherein the hydroxy carboxylic acid salt has a melting range of 50° C. to 180° C., in particular of 70° C. to 180° C. and is preferably a metallic soap from the group of calcium, magnesium and/or zinc soaps.

Examples of such waxes which can be used as component (B) are listed in table 1.

If a mixture of such a wax or several such waxes with castor wax is used, the proportion by weight of this wax or wax mixture of the component (B) is 1 to 99%, preferably 2 to 70%.

TABLE 1

| No. | chem. Term | trade name | mp. ° C. | manufacturer |
|---|---|---|---|---|
| 1 | partially hydrated | Castor wax | 70-80 | NL |
| | castor oil | MP 80 | | Industries, |
| | | | | Inc. |
| | | Castor wax | 70-80 | NL |
| | | MP 70 | | Industries, |
| | | | | Inc. |
| 2 | Triglyceride consisting | (a) EDENOL | Liquid | Cognis/ |
| | of mono-, di-, | 81/82 | | Henkel |
| | trihydroxy carboxylic | (a) EDENOL | Liquid | Cognis/ |
| | acid and carboxylic | B35 | | Henkel |
| | acids, produced | (a) EDENOL | Liquid | Cognis/ |
| | through hydration of | B316 | | Henkel |
| | epoxidized oil(s), fats, | | | |
| | waxes with a high | | | |
| | content of oleic acid | | | |
| | and/or eruic acid, | | | |
| | linoleic acid, linolenic | | | |
| | acid and other uni- | | | |
| | or poly-unsaturated | | | |
| | fatty acids produced | | | |
| | from rape oils, olive | | | |
| | oils, sunflower oils, | | | |
| | castor oil, triolein, | | | |
| | soy oils, linseed oils | | | |
| | and other oils | | | |
| 3 | Trigylycerides | (b) soy oils | | |
| | consisting of di-, tri-, | (b) rape oils | | |
| | polyhydroxy | (b) sunflower | | |
| | carboxylic acids | oils | | |
| | and carboxylic acids, | (b) castor | | |
| | produced through | oils | | |
| | hydroxylation of uni- | (b) olive oils | | |
| | and poly- | (b) linseed | | |
| | unsaturated oils (b), | oils | | |
| | fats and waxes | (b) other | | |
| | | native oils | | |
| 4 | Hydroxy carboxylic | | | |
| | acid amides | | | |
| 5 | Hydroxy carboxylic | LIGA | 135-155 | Greven |
| | acid salts, in particular | Calcium-12- | 120-140 | Fettchemie |
| | of Ca, Mg, Zn | oxy stearate | | Barlocher |
| | | magnesium- | | |
| | | 12-hydroxy | | |
| | | stearate | | |

The waxes of component (B)—see table 1, examples 1 to 3—consist of esters of glycerine which contain linear, branched or cyclic, partially saturated or saturated, partially hydrated or fully hydrated, dimerized and polymerised hydroxy carboxylic acids and/or carboxylic acids. Esters of the glycerine conventionally contain at least a residue of an acid and at least a residue of the polyol glycerine. The esters or waxes used in accordance with the invention are known per se. The hydroxy carboxylic acid esters of the glycerine to be used in accordance with the invention contain residues of (C₁-C₄₀) hydroxy carboxylic acids and (C₁-C₄₀) carboxylic acids with molecular weights in the range between 40 and 2,000.

Further waxes suitable as component (B)—see table 1, example 4-include amides which contain linear, branched or cyclic, partially saturated or unsaturated, partially hydrated or fully hydrated, dimerized and polymerized hydroxy carboxylic acid amides. Hydroxy carboxylic acid amides conventionally contain at least a residue of a hydroxy carboxylic acid and at least a residue of an amide group. The amides or waxes used in accordance with the invention are known per se. The hydroxy carboxylic acid amides to be used in accordance with the invention contain residues of (C₁-C₄₀) hydroxy carboxylic acids with gram-molecular weights in the range of 40 to 2,000.

Further waxes suitable for component (B)—see table 1, example 5-include metallic soaps of a hydroxy carboxylic acid, preferably on the basis of calcium, magnesium- and zinc soaps which are linear, branched or cyclic, partially saturated or unsaturated, partially hydrated or fully hydrated, dimerized compounds. Such metallic soaps contain at least one hydroxy carboxylic acid residue which forms fatty acid salts (metallic soaps) with monovalent metals such as lithium, sodium, potassium and with bivalent or multivalent metals such as magnesium, calcium, aluminium, zinc and iron. The metallic soaps on the basis of hydroxy carboxylic acids to be used in accordance with the invention preferably have a chain length of C₁-C₄₀ and a gram-molecular weight in the range of 40 to 2,000 and have mono-, bi- and multivalent metals.

The inventive composition may contain further substances (component C) in addition to the components (A) and (B). These additional substances are e.g. fillers, sliding agents, plasticising agents, modificators (tensile strength, rigidity, impact strength, resistance to tear propagation and processing viscosity) and stabilizers, flame retardants, colorants, inorganic and organic pigments, carbon black, foaming agents or other additives known per se in polymeric chemistry. These additives have functional properties such as antistatics, antifogging, fungicides, pesticides, herbicides, fertilisers etc. The additives are added to the composition in amounts known per se.

Fillers are e.g. titanium dioxide, calcium carbonate, dolomite, iron oxides, talcum, kaolin, mica, bentonite, magnesium oxide, silicium dioxide pyrogen or precipitated, aluminium oxide, chitosane, cellulose fibers or plant fibers, hemi-cellulose, cellulose ester, cellulose ether, starch ester, starch ether, hydroxy alcyl cellulose, hydroxy alcyl starch, ceramic powder or wood. The fillers are preferably used in a portion by weight of 3-40%, preferably 5-25%, in particular 10-20% relative to the overall weight of the composition depending on the type.

Sliding agents are e.g. calcium stearate, aluminium stearate, magnesium stearate, fatty acid amides/imides, lecithines, mono- or diglycerides contained in a concentration between 0.5 and 5% by weight, preferably 0.7 to 1.5% by weight relative to the overall weight of the composition.

Plasticising agents are e.g. polyalkylene oxides, preferably polyethylene glycols or polypropylene glycols whose terminal hydroxylic groups are estered or ethered, ethylene glycol, propylene glycol, sorbitol, glycerine, mono- and/or poly glycerine, glycerine mono-, di- or triacetate, urea, glycine, proline, zein, pentaerythrite, triethylcitrate, tributylcitrate, fatty alcohols, such as stearyl alcohol and further plasticising agents known per se.

Modificators of the tensile strength, rigidity, impact strength, resistance to tear propagation and processing viscosity are e.g. other commercially available biologically degradable materials (BAW) such as polyester, copolyester (Ecoflex BASF), polyhydroxy carboxylic acids (Ecopla Dow/Cargill), polyester amides (BAK Bayer), other BAWs and calcium-, magnesium-, zinc salts of hydroxy carboxylic acids and of urea acids; as well as crystalline polyoles and polyol/ether compounds such as e.g. Di(trimethylol propane). Similar modifications are obtained through substances such as talcum, layer silicates and plant fibers. These modificators are contained in concentrations of 0.1-30% by weight, preferably 1-20% by weight, preferably 2-10% by weight.

Stabilisators are e.g. antioxidants, UV absorbers, UV quenchers, bactericides or fungicides known per se which are used in amounts known per se.

Flame retardants are e.g. compounds containing nitrogen, phosphor, sulfur or halogen or mixtures thereof. Such flame retardants are known per se. The flame retardants are contained, in particular, in amounts of 0.1 to 10% by weight, preferably 1-6% by weight and most preferred 2-4% by weight relative to the overall weight of the composition.

Inorganic or organic pigments, preferably conventional biologically degradable or ecologically compatible colorants/pigments are used as colorants in amounts known per se. Nucleation means are e.g. the mentioned fillers or magnesium silicate (microtalcum) of a particle size of between 0.1 and 5 μm. These are preferably contained in a concentration of 0.1-3% by weight, preferably 0.1-0.5% by weight.

Foaming agents are known per se, e.g. a combination of sodium bicarbonate and citric acid and similar commercially available foaming agents. It is also possible to directly add gaseous nitrogen or carbon dioxide to the molten composition in the extruder. It is also possible to mix the inventive composition with calcium carbonate and 12-hydroxy stearic acid during an extrusion process and foam it with the generated carbon dioxide. The foaming agent is preferably added in a concentration between 0.1-2% by weight relative to the overall weight of the composition.

The inventive composition can be processed like conventional thermoplastic materials using a conventional device which is suited e.g. for tubular film production, blow molding, extrusion and coextrusion (rod, tube and film extrusion), press forming, injection molding processing, doctoring, foaming, casting methods or further processing methods known per se to produce objects known per se. These articles include e.g. foils, bags, sacks, tubes, rods, bottles, cups, packaging materials and other conventional objects in all processing stages from powders, granulated matter and intermediate products to finished products. To vary the properties, the above-mentioned objects can be produced in one layer, several layers or another manner known per se. The inventive composition can thereby be combined with other materials and be used as surface and/or carrier layer. The foils may thereby be further processed in the unstretched and cold- or warm-stretched state. The cold-stretched foils are very soft and have a so-called soft touch. These objects are mainly used in areas where disposal has been a major problem up to now such as e.g. in the field of agriculture as agricultural foil or plant pots, in the field of disposal as composting bags, in the field of packaging as carrier bags, shrinking foils, shampoo bottles, cups or cutlery. Moreover, e.g. tube foils for the production of bags and sacks, agricultural foils, injection- and blow-molded articles, hot melts and fillers can also be produced. Water-sensitive products can also be surface coated. The soft stretched foils can constitute a barrier layer to prevent the “wetting through” of paper fleeces e.g. for paper tissues or other hygienic applications.

The inventive composition can be produced in different ways e.g. through stirring the molten components (A) and (B) in a container and simultaneous or subsequent addition of additives; mixing of all components in single-screw extruders, double-screw extruders with identical or opposite motion, planetary roller extruders, pumping of the components into a static mixer or through other suitable mixing methods known per se which are suited for homogeneously mixing the components due to their temperature control, shearing, pressure and retention times.

It is also possible to produce intermediate materials which can then be processed into the inventive product.

The inventive mixtures are characterized by an adjustable melt viscosity permitting easy processing of various applications from paper coating to blown foil. The elasticity or rigidity can be largely varied to thereby obtain either comparatively rigid or elastic foils.

### EXAMPLES 1 THROUGH 6, COMPARATIVE EXAMPLES 7 AND 8

Methodology:

Laboratory Z vacuum kneader with delivery screw (LINDENLK III 1 A) mixing and delivery region in V4A steel (material no.: 1.4571/1.4581)

Oil thermostat: (Lauda USH 400)

Dosing vibration channel: (Fritsch Laborette)

Granulator: (Collin CSG 171 T)

Methodology for Examples 1 Through 6:

Polycaprolactone [component (A)] is added to the laboratory kneader in batches via a dosing channel and melted at 120° C. mass temperature. Castor wax [component (B)] is added under further mixing and kneading. Due to the high portion of castor wax, an inhomogeneous mixture is initially formed during 15-20 minutes at 120° C. until a homogeneous and kneadable mixture is also obtained through diffusion and distribution. After another 15 minutes of kneading, the mixture is quickly cooled to 90-95° C. and subsequently extruded into a strand via the delivery screw through the hole nozzle. This strand is cooled in a water bath and subsequently granulated. During processing, good mixing and kneading must be ensured. The individual compositions are shown in table 2.

| | | Example no. | | | | | | | |
|---|---|---|---|---|---|---|---|---|---|
| | | 1 | 2 | 3 | 4 | 5 | 6 | 7 | 8 |
| Tone ® P787 | Union | 300 g | 350 g | | | | | 500 g | |
| | Carbide | | | | | | | | |
| Capa ® 680 | Solvay | | | 300 g | 350 g | | | | 500 g |
| Capa ® 650 | Solvay | | | | | 300 g | 350 g | | |
| Loxiol ® G15 | Cognis | 200 g | 150 g | 200 g | 150 g | 200 g | 150 g | | |
| DSC curve | | | | | | | | | |

In table 2:

Tone® P787: PCL, molecular weight approximately 80,000

melting point approx. 60-62° C.

MFI 1.0 (125° C.) ASTM D1238-73)

Capa® 680: PCL, molecular weight approx. 80,000

melting point approx. 60-62° C.

crystallization temperature 27.4° C.

crystallinity 56%

MFI 0.6 (80° C., 2.16 kg g/10 min)

Capa® 650: PCL, molecular weight approx. 50,000

melting point approx. 60-62° C.

crystallization temperature 25.2° C.

crystallinity 56%

MFI 2.36 (80° C., 2.16 kg g/10 min)

Loxiol® G15: castor wax, melting point 83-90° C.

iodine number 0-5

acid number 0-5

saponification number 175-185

hydroxylic number 140-165

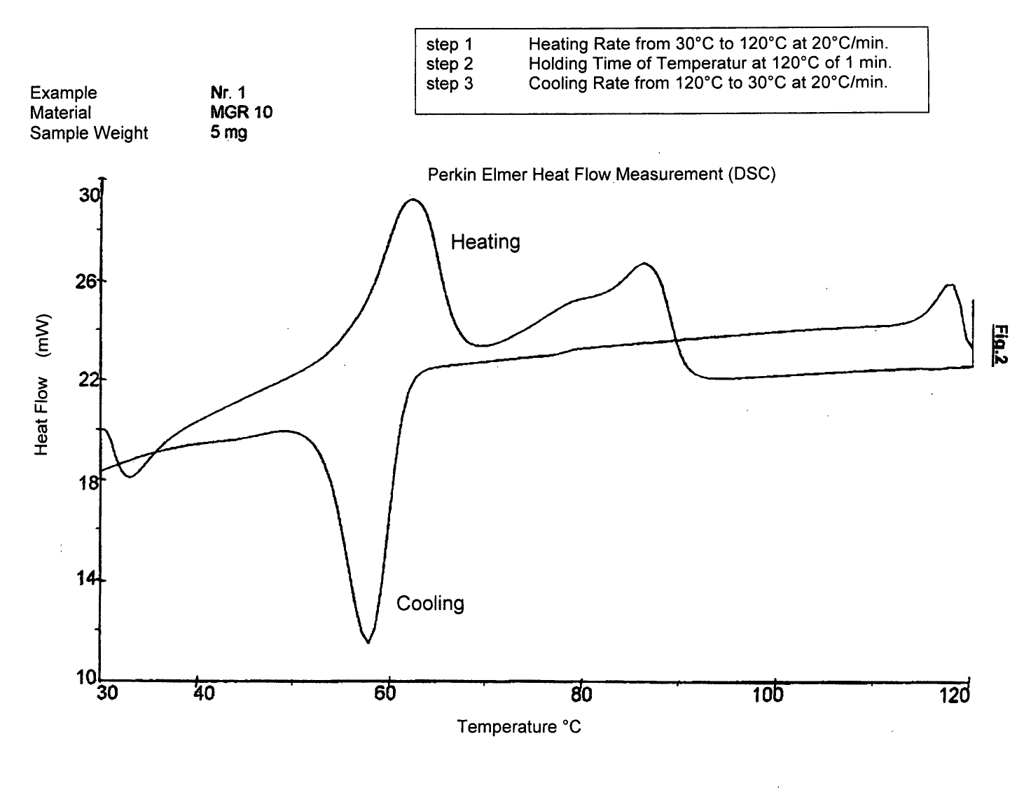

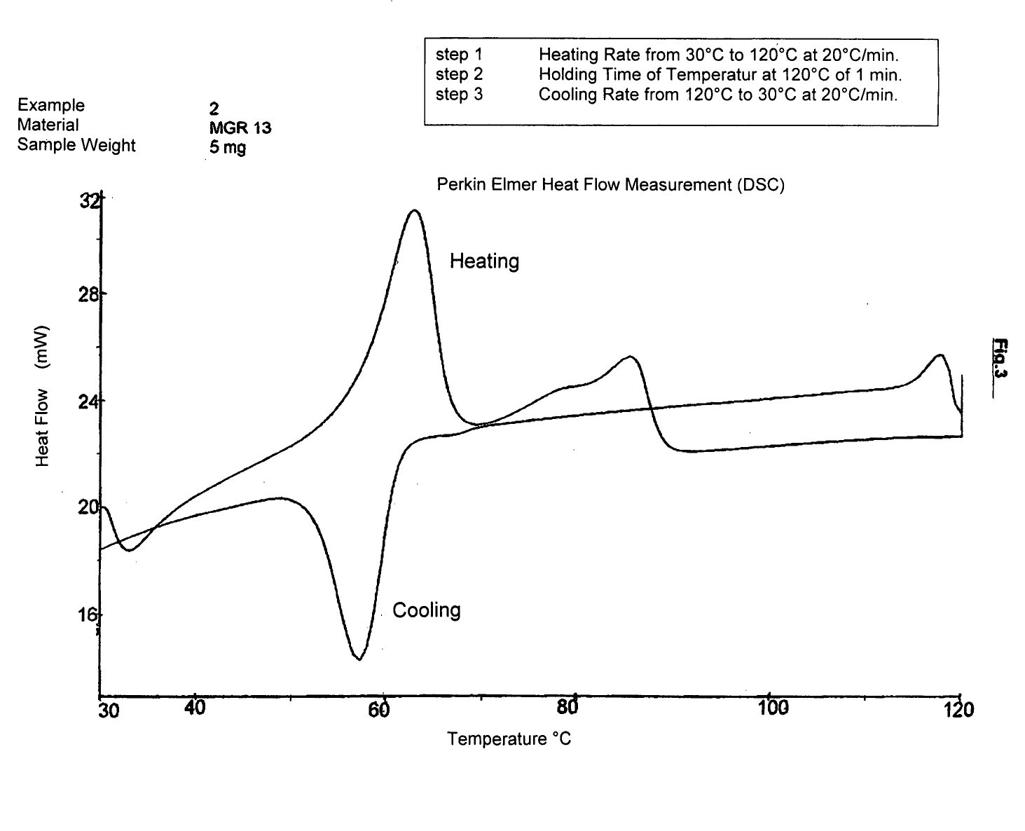

The compositions of examples 1 through 6 are characterized by excellent processing properties which can be demonstrated in particular for the production of foils. For the production of blown foil it is advantageous when the processed materials have a distinct crystallization point (see DSC curves, FIGS. 2 and 3) which is clearly above room temperature such that the foil can be easily solidified after leaving the nozzle through air cooling. This is not the case for pure PCL (comparative examples 7 and 8, see DSC curve FIG. 1), since the crystallization region is <350 and therefore special cooling must be used for solidification. This is not required for the compositions of examples 1 through 6, since the crystallization temperature is approximately 58° C. Pure castor wax is brittle and cannot be processed into blown foil through extrusion.

Mixtures with highly molecular PCL showed a very good blow behavior for the production of blown foils. It was thereby possible to reduce the processing viscosity and therefore also the torque and processing temperature with increasing wax content; the crystallization temperature of the composition did not change substantially when the wax content varied. Even for large wax content (40% by weight) of the inventive composition, the mechanical properties obtained were almost equal to those of pure polycaprolactone. It was also possible to obtain very thin foils of down to 8 μm which is unusual for biologically degradable materials.

Addition of a further wax has shown that the combination of several waxes for component B of the inventive composition permitted more variable setting of the melt viscosity. Higher viscosities can thereby be achieved as are required e.g. for deep drawing and blow forming. This component also increases the viscosity and rigidity of the products.

Due to the distinct gelling behavior of the metallic soaps, premixing of the components of table 3 (examples 9-11) proves to be advantageous and permits pinhole-free mixing of the inventive composition. These mixtures permit an increase in the processing viscosity compared to example 15 and an improved crystallization behavior compared to the initial compound polycaprolactone (CAPA 680).

### EXAMPLES 9 THROUGH 12

Method for Producing a Pre-Mixture:

Magnetic stirrer with heating plate IKAMAG RCT (Jahn and Kunkel) 1.5 l stainless steel pot (conventional)

Laboratory stirring machine: (Heidolph RZR 50 L)

Laboratory stirring tool: (propeller head: 100 mm)

Method for Producing a Pre-Mixture (Examples 9 Through 11)

LOXIOL® G15 [component (B)] is added in batches to the stainless steel pot and melted at 120° C. mass temperature while stirring (50-200 R/min). LIGA® calcium-12-oxystearate (see examples 9-11) is added as component (B I) while continuing to mix (200-500 R/min) and the mixture is heated to 160° C. The mixture is then cooled to 140° C. and poured into a Teflon-coated tub and solidified into a plate. This plate is ground with a grating machine (Schulte)—grating insert 1 for fine grain—and further processed (see table 4 and examples 12-14).

TABLE 3

| | | Examples no. | | |
|---|---|---|---|---|
| | | 9 | 10 | 11 |
| Loxiol ® G15 | Cognis | 475 g | 450 g | 400 g |
| (B) | | | | |
| LIGA ® 12- | Greven | 25 g | 50 g | 100 g |
| oxy stearate | Fettchemie | | | |
| (B I) | | | | |

In table 3:

Loxiol® G15: melting point 83-90° C.

(castor wax) iodine number 0-5

acid number 0-5

saponification number 175-185

hydroxylic number 140-165

LIGA® calcium-12-oxy stearate: melting point 135-147° C.

(calcium-12-hydroxy stearate) free fatty acid <1%

moisture <3%

### EXAMPLES 12 THROUGH 14, COMPARATIVE EXAMPLE 15

Method structure:

Laboratory Z vacuum kneader with delivery screw (LINDEN LK III 1A) mixing and delivery region in V4A steel (material no.: 1.4571/1.4581)

Oil thermostat: (Lauda USH 400)

Dosing vibration channel: (Fritsch Laborette)

Granulator: (Collin CSG 171 T)

### PROCEDURE FOR EXAMPLES 12 THROUGH 14, COMPARATIVE EXAMPLE 15

Polycaprolactone [component (A)] is added in batches to the laboratory kneader via a dosing channel and melted at 120° C. mass temperature. The ground pre-mixtures of examples 9-11 are added as [component (B)] thereby further mixing and kneading. After a further 15 minutes of kneading at 120-160° C., the mixture is quickly cooled to 100-110° C. and subsequently extruded into a strand by the delivery screw via the hole type nozzle. This strand is cooled in the water bath and subsequently granulated. Good mixing and kneading must be ensured during processing. The individual compositions are combined in table 4.

TABLE 4

| | | Examples no. | | | |
|---|---|---|---|---|---|
| | | 12 | 13 | 14 | 15 |
| Capa ® 680 | Solvay | 300 g | 300 g | 300 g | 300 g |
| Pre- | Example | 200 g | | | |
| mixture | no. 9 | | | | |
| Pre- | Example | | 200 g | | |
| mixture | no. 10 | | | | |
| Pre- | Example | | | 200 g | |
| mixture | no. 11 | | | | |
| Loxiol G 15 | Cognis | | | | 200 g |

In table 4:

Capa® 680: PCL molecular weight approx. 80,000

melting point approx. 60-62° C.,

crystallization temperature 25.2° C.

crystallinity 56%

MFI 0.6 (80° C., 2.16 kg g/10 min)

Pre-mixture examples 9 through 11: see table 3

1. Composition containing
(A) at least one crystalline polycaprolactone (PCL) or a mixture of such polycaprolactones and
(B) at least one wax having a melting point in the region between 50° C. and 180° C. or a mixture of such waxes and
(C) optionally further additives characterized in that the wax of the component (B) is selected from the group
castor wax, i.e. partially or completely hardened (hydrated) castor oil and/or
triglycerides of partially or completely hydrated mono-, di- and/or trihydroxy carboxylic acids and carboxylic acids and/or
triglycerides of partially or completely hydroxylated di-, tri- and/or polyhydroxy carboxylic acids and carboxylic acids and/or
hydroxy carboxylic acid amides and/or
hydroxy carboxylic acid salts,
wherein the weight ratio between the component (A) and component (B) is between approximately 05:95 and 95:05.

2. Composition according to claim 1, characterized in that the component (A) comprises highly crystalline polycaprolactone with a molecular weight of approximately 20,000 to 180,000, a melting range of approximately 50° C. to 120° C., and a crystallization temperature of less than 40° C.

3. Composition according to claim 2, characterized in that the melting range of the component (A) is between 58° C. and 62° C.

4. Composition according to any one of the claims 1 through 3, characterized in that the weight ratio between component (A) and component (B) is in a range of approximately 20:80 and 80:20, in particular between approximately 40:60 to 70:30.

5. Composition according to any one of the claims 1 through 4, characterized in that the component (B) comprises a solidified castor oil (castor wax) having a melting point of between approximately 81° C. and 92° C.

6. Composition according to any one of the claims 1 through 4, characterized in that the component (B) comprises a triglyceride of hydrated mono-, di- and/or trihydroxy carboxylic acids and carboxylic acids and/or a triglyceride of hydroxylated di-, tri- and/or poly hydroxy carboxylic acids and carboxylic acids or a mixture of such triglycerides or several such triglycerides with castor wax, wherein the triglyceride has a melting range between 50° C. and 180° C., in particular of 70° C. to 180° C.

7. Composition according to any one of the claims 1 through 4, characterized in that the component (B) comprises a hydroxy carboxylic acid amide or a mixture of such hydroxy carboxylic acid amides or of several such hydroxy carboxylic acid amides with castor wax, wherein the hydroxy carboxylic acid amide has a melting range between 50° C. and 180° C., in particular 70° C. to 180° C.

8. Composition according to any one of the claims 1 through 4, characterized in that the component (B) comprises a hydroxy carboxylic acid salt or a mixture of such hydroxy carboxylic acid salts or of several such hydroxy carboxylic acid salts with castor wax, wherein the hydroxy carboxylic acid salt has a melting range between 50° C. and 180° C., in particular 70° C. to 180° C.

9. Composition according to claim 8, characterized in that the hydroxy carboxylic acid salt is a metallic salt of the group of calcium-, magnesium- and/or zinc soaps.

10. Composition according to any one of the claims 6 through 9, characterized in that the weight portion of triglyceride of hydrated mono-, di- and/or trihydroxy carboxylic acids and carboxylic acids and/or of the triglyceride of hydroxilated di-, tri- and/or poly hydroxy carboxylic acids and carboxylic acids and/or the hydroxy carboxylic acid amide and/or hydroxy carboxylic acid salt or a mixture of such triglycerides, hydroxy carboxylic acid amide and/or hydroxy carboxylic acid salts of the component (B) is approximately 1% to 99%, in particular approximately 10% to 70%.

11. Composition according to any one of the claims 1 through 10, characterized in that it contains further additives which are selected from the group of fillers, sliding agents, plasticising agents, stabilizers, flame retardants, colorants, inorganic and organic pigments, foaming means and modificators of tensile strength, rigidity, impact strength, resistance to tear propagation, processing viscosity, or other additives known per se in polymeric chemistry.

12. Composition according to any one of the claims 1 through 11, characterized in that it has been processed using a conventional device, which is suited for tube foil production, blow forming, deep drawing, extrusion and co-extrusion (rod, tube and film extrusion) press forming, injection molding, doctoring, foaming, casting, spraying, painting, lamination and immersion methods.

13. Objects in the form of foils, bags, sacks, tubes, rods, bottles, cups, packaging materials, each optionally in the form of one or several layers, cold or warm-stretched, foamed, as powder, granulated matter or semi finished products, produced from a composition in accordance with one of the claims 1 through 12.

14. Objects in the form of agricultural foils, plant pots, compost bags, carrier bags, shampoo bottles, plates, boards, cutlery, tube foils for the production of bags and sacks, injection molding and blow forming articles, hot melts or fillers produced from the composition in accordance with any one of the claims 1 through 12.

15. Objects according to claim 13 or 14, comprising a surface coating of a composition in accordance with any one of the claims 1 through 12.

16. Method for producing a composition according to any one of the claims 1 through 12, characterized in that the molten components (A) and (B) are mixed in a suitable device and the optional additives are added simultaneously or subsequently.
